(19) United States
(12) Patent Application Publication
(10) Pub. No.: US 2013/0201298 A1
(43) Pub. Date: Aug. 8, 2013

(54) APERTURE FOR INCREASING THE PARALLAX IN A SINGLE LENS THREE DIMENSIONAL CAMERA

(71) Applicants: John S. Laudo, Hilliard, OH (US); C. Alexander Morrow, Gahanna, OH (US)

(72) Inventors: John S. Laudo, Hilliard, OH (US); C. Alexander Morrow, Gahanna, OH (US)

(73) Assignee: BATTELLE MEMORIAL INSTITUTE, Columbus, OH (US)

(21) Appl. No.: 13/637,885

(22) PCT Filed: Apr. 1, 2011
(86) PCT No.: PCT/US2011/030898

§ 371 Date: Nov. 6, 2012

Related U.S. Application Data
(60) Provisional application No. 61/320,523, filed on Apr. 2, 2010.

(51) Int. Cl. H04N 13/02

(52) U.S. Cl. CPC H04N 13/0225
USPC 348/49

(57) ABSTRACT

A stereoscopic camera (10) is provided comprising: an image sensor (14); a lens system (20) adapted to focus light from a scene (O₁) onto the image sensor (14); a dividing device (30) associated with the lens system (20) for dividing the lens system (20) into two portions; and a structure (30A) associated with the lens system (20) defining an aperture (41, 42) limiting an amount of light passing through at least a portion of the lens system (20). The aperture has a first length (L₁) in a horizontal dimension which is greater than a second length (L₂) in a vertical dimension.

### TECHNICAL FIELD

The present invention relates to a single lens three dimensional stereoscopic camera comprising an aperture structure for limiting an amount of light passing through at least a portion of a lens system, and more particularly, to such a camera including structure defining an aperture having a first length in a horizontal dimension which is greater than a second length in a vertical dimension such that an effective f-number of the lens system in the vertical dimension is greater than the an effective f-number of the lens system in the horizontal dimension. The reduction of the second length in the vertical dimension increases the parallax spacing when used on a single lens, three dimensional, stereoscopic camera.

### BACKGROUND ART

One known method of using a single camera to capture three-dimensional information is to employ a dividing device, such as a shutter device, for sequentially allowing left and right D-shaped views of a scene to pass through a lens for subsequent imaging on an image sensor. Parallax spacing is normally defined as the separation between the centroids of the left and right D-shaped views at the lens. In this case, the centroids are close to the center of the lens. It is desirable to have the parallax large so as to approach that of human vision, which is about 65 mm. However, this requires a large lens diameter operating at a low f-number. The low f-number imposes an additional constraint on the performance of the camera, namely, a reduced depth of field. This causes some information in a scene not in focus to blur and reduces the three-dimensional effect.

### DISCLOSURE OF INVENTION

In accordance with a first aspect of the present invention, a stereoscopic camera is provided comprising: an image sensor; a lens system adapted to focus light from a scene onto the image sensor; a dividing device associated with the lens system for dividing the lens system into two portions; and a structure associated with the lens system defining an aperture limiting an amount of light passing through at least a part of the lens system. The aperture has a first length in a first dimension, e.g., a horizontal dimension, which is greater than a second length in a second dimension, e.g., a vertical dimension, so as to increase the parallax of the lens system.

The dividing device may comprise a mechanical shutter.

Alternatively, the dividing device may comprise an electronically actuatable matrix shutter capable of being actuated by a processor so as to sequentially create right and left pupils.

The dividing device may be located upstream of the lens system. The aperture structure may be located adjacent to the dividing device and upstream of the lens system.

The dividing device and/or the aperture structure may be located at an aperture stop of the lens system.

The aperture structure may comprise a plate including an opening defining the aperture having a first length in a horizontal dimension which is greater than a second length in a vertical dimension.

The aperture structure may also comprise a set of adjustable blades in at least the vertical dimension. Adjustable blades in the horizontal dimension may be provided but only serve to reduce the parallax and f-number of the lens system. The adjustable aperture structure may be used with a dividing device.
The dividing device may comprise: a passive polarizer structure defining right and left portions of different polarization states; and an active polarization selector which is controlled so as to sequentially allow light from the left and right portions of the polarizer structure to pass through the lens system. The passive polarizer structure may further define the aperture structure.

The lens system may comprise a double-gauss lens.

The aperture first length may be substantially equal to a diameter of the lens system.

The dividing device may sequentially divide the lens system into two portions.

In accordance with a second aspect of the present invention, a stereoscopic camera is provided comprising: an image sensor; a lens system adapted to focus light from a scene onto the image sensor; a dividing device associated with the lens system for dividing the lens system into two portions; and a structure associated with the lens system defining an aperture limiting an amount of light passing through at least a part of the lens system. The aperture has a first length in a horizontal dimension which is greater than a second length in a vertical dimension such that an overall f-number of the lens system is increased when compared to a lens system having an generally circular aperture with a diameter substantially equal to the first length.

### BRIEF DESCRIPTION OF DRAWINGS

FIG. 1 is a schematic top view of a stereoscopic camera constructed in accordance with a first embodiment of the present invention;

FIG. 1A is a perspective view of an electronically actuatable matrix shutter;

FIG. 2 is a schematic view of a dividing device defining left and right portions of an aperture;

FIG. 2A illustrates first left and right perspective images of a scene allowed to pass to an image sensor by the dividing device of FIG. 2;

FIG. 3 is a schematic view of a dividing device defining left and right D-shaped portions of an aperture;

FIG. 3A illustrates second left and right perspective images of a scene allowed to pass to an image sensor by the dividing device of FIG. 3;

FIG. 4 illustrates a camera taking an image of a scene comprising text on a wall and a door;

FIG. 5 is a schematic top view of a stereoscopic camera constructed in accordance with a second embodiment of the present invention;

FIG. 6 is a view of an aperture structure incorporated into the camera of FIG. 5;

FIG. 7 is a schematic top view of a stereoscopic camera constructed in accordance with a third embodiment of the present invention;

FIG. 7A is a view of a passive polarizer structure of a dividing device of the camera of FIG. 7;

FIG. 8 illustrates raytrace analysis data; and

FIG. 9 illustrates a plot of parallax vs. height for a stereoscopic lens system with an aperture having a first length equal to the diameter of the lens system.

### MODES FOR CARRYING OUT THE INVENTION

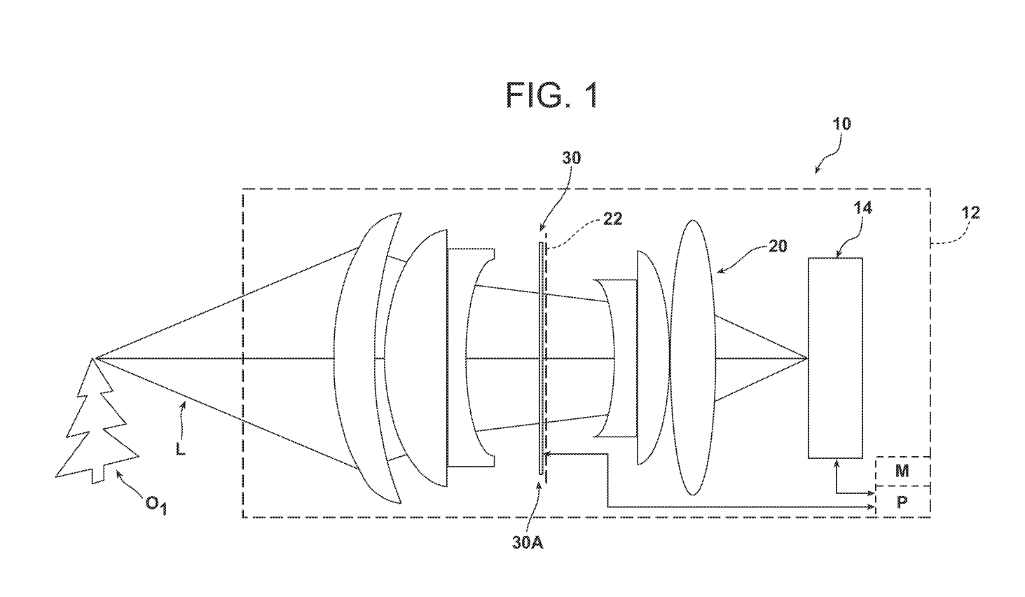

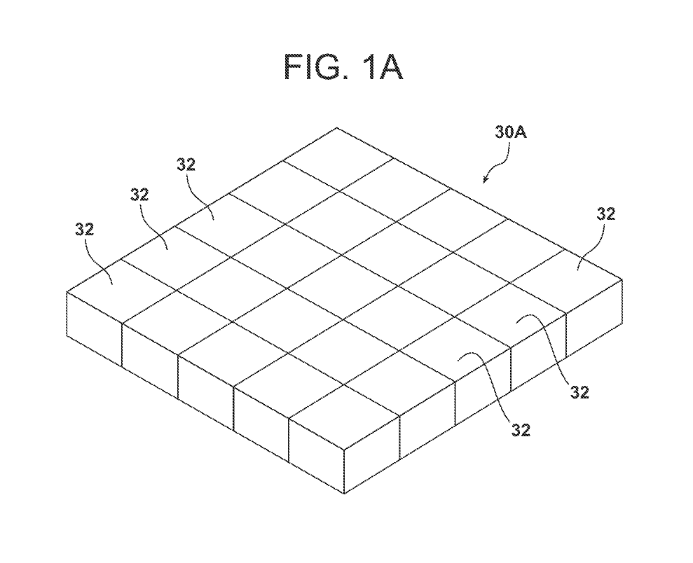

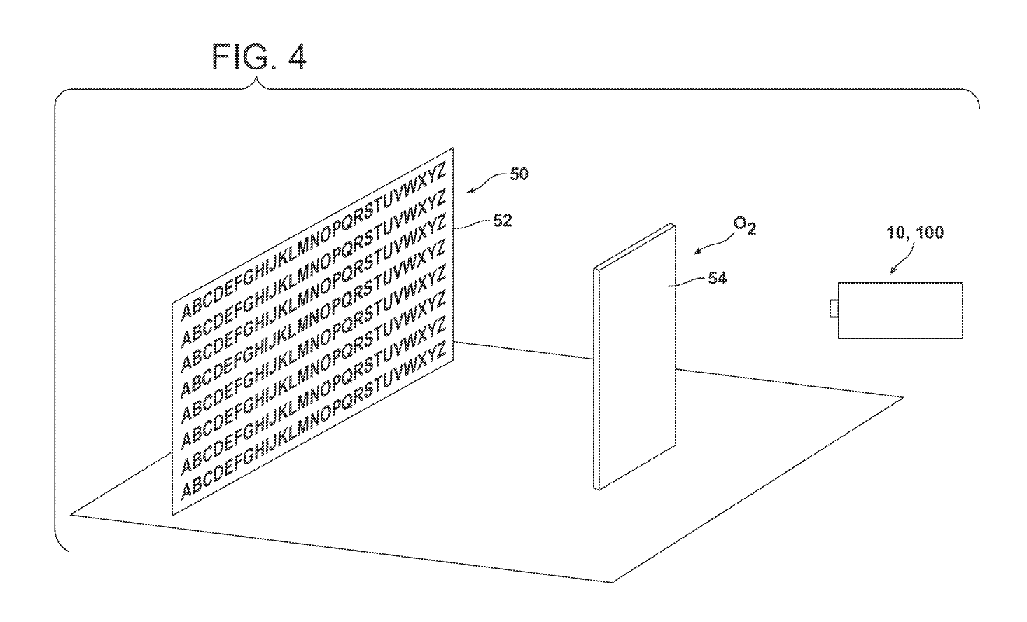

In accordance with the present invention, a stereoscopic camera 10 capable of generating a 3-dimensional (3-D) still image or video images is provided comprising a housing 12, an image sensor 14, a lens system 20, a dividing device 30 for separating the lens system 20 into first and second portions, an aperture structure, a memory M and a processor P, see FIGS. 1 and 4. In the embodiment illustrated in FIG. 1, the dividing device 30 also defines the aperture structure. The processor P is coupled to the memory M, and may be coupled to the dividing device 30 if it is electronically actuatable and the image sensor 14 if it is electronic.

The lens system 20 may comprise a conventional double-gauss lens.

The dividing device 30 and the aperture structure are preferably located at an aperture stop or aperture plane 22, which, in the illustrated embodiment, is defined within the lens system 20, see FIG. 1. It is contemplated that the dividing device 30 and the aperture structure may be placed forward (upstream from) or behind (downstream of) the aperture plane 22, which placement of the dividing device 30 and the aperture structure may cause vignetting of outer edges of the image. For example, the dividing device 30 and the aperture structure may be positioned in front of or behind the lens system 20 but these positions are less favorable due to increased vignetting of the image.

Light L from an object or scene O₁ passes through the lens system 20, which focuses the light, i.e., the light rays, onto the image sensor 14, see FIG. 1.

In the illustrated embodiment, the image sensor 14 may comprise an electronic image sensor such as a charged-coupled device (CCD) array or a complementary metal-oxide-semiconductor (CMOS) array. The CCD or CMOS array receives an image focused by the lens system 20 and generates an electronic image signal related to the amount of light received. The electronic image signal is provided to the processor P which processes the electronic image signal and stores corresponding image data in the memory M. It is also contemplated that the image sensor 14 may comprise a non-electronic image sensor such as analog film.

In one embodiment of the present invention, the dividing device 30 functions to sequentially block light passing through left and right halves of the lens system 20 so as to provide right-eye and left-eye views of the object or scene O₁, which are imaged by the image sensor 14. The dividing device 30 and the image sensor 14 are synchronized and controlled by the processor P such that when the dividing device 30 blocks light through the left half of the lens system 20 and allows light to pass through the right half of the lens system 20, a right image of the object or scene O₁ is focused by the lens system 20 onto an image plane of the image sensor 14. In a similar manner, the dividing device 30 and the image sensor 14 are synchronized and controlled by the processor P such that when the dividing device 30 blocks light through the right half of the lens system 20 and allows light to pass through the left half of the lens system 20, a left image of the object or scene O₁ is focused by the lens system 20 onto the image plane of the image sensor 14.

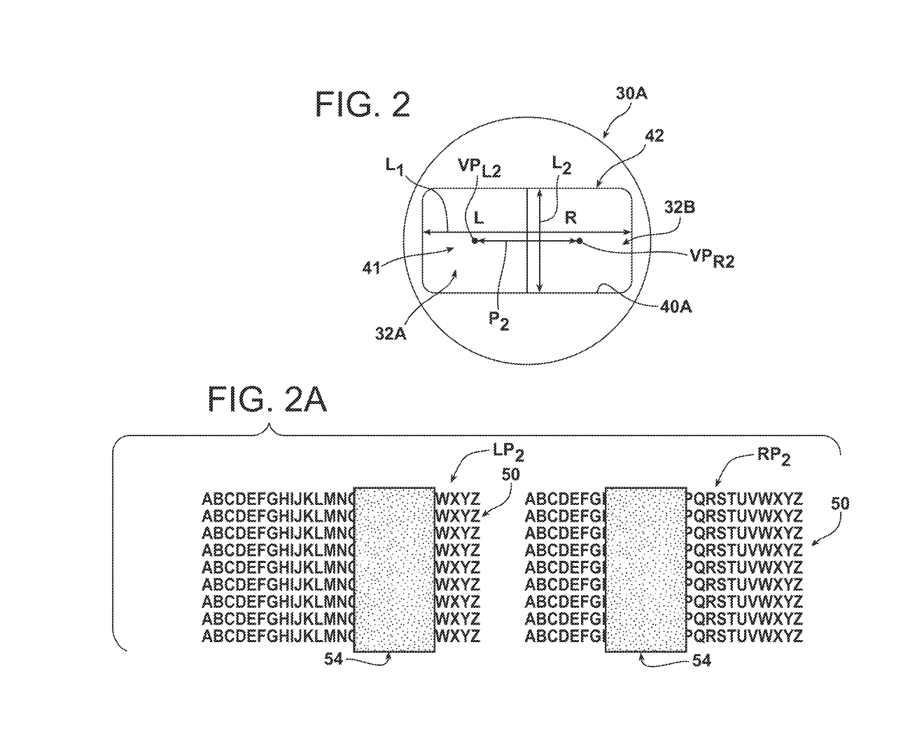

In the embodiment illustrated in FIG. 1, the dividing device 30 comprises an electronically actuatable matrix shutter 30A, which comprises a liquid crystal element comprising a two-dimensional array of individually addressable and actuatable shutter elements 32, see FIGS. 1A and 2. The processor P controls the matrix shutter 30A in accordance with first and second exposure patterns stored in the memory M so as to actuate a first set 32A of shutter elements 32 for a first predefined time period to define a first or left pupil 41 in the matrix shutter 30A, and then a second set 32B of shutter elements 32 is actuated for a second predefined time period to define a second or right pupil 42 in the matrix shutter 30A, see FIG. 2. The first and second predefined time periods may be equal to one another in length but occur sequentially. When the first set 32A of shutter elements 32 are actuated, they become light transmissive so as to allow light to pass through the matrix shutter left pupil 41 and the lens system 20 and impinge on the image sensor 14. When the first set 32A of shutter elements 32 are actuated, the second set 32B of shutter elements 32 are not actuated and, hence, those shutter elements are in an opaque state. When the second set 32B of shutter elements 32 are actuated, they become light transmissive so as to allow light to pass through the matrix shutter right pupil 42 and the lens system 20 and impinge on the image sensor 14. When the second set 32B of shutter elements 32 are actuated, the first set 32A of shutter elements 32 are not actuated and, hence, those shutter elements are in an opaque state.

As noted above, in the embodiment illustrated in FIG. 1, the matrix shutter 30A also functions as the aperture structure so as to define an aperture 40A limiting the amount of light passing through the lens system 20 to the image sensor 14. The aperture 40A is defined sequentially by the first and second pupils 41 and 42.

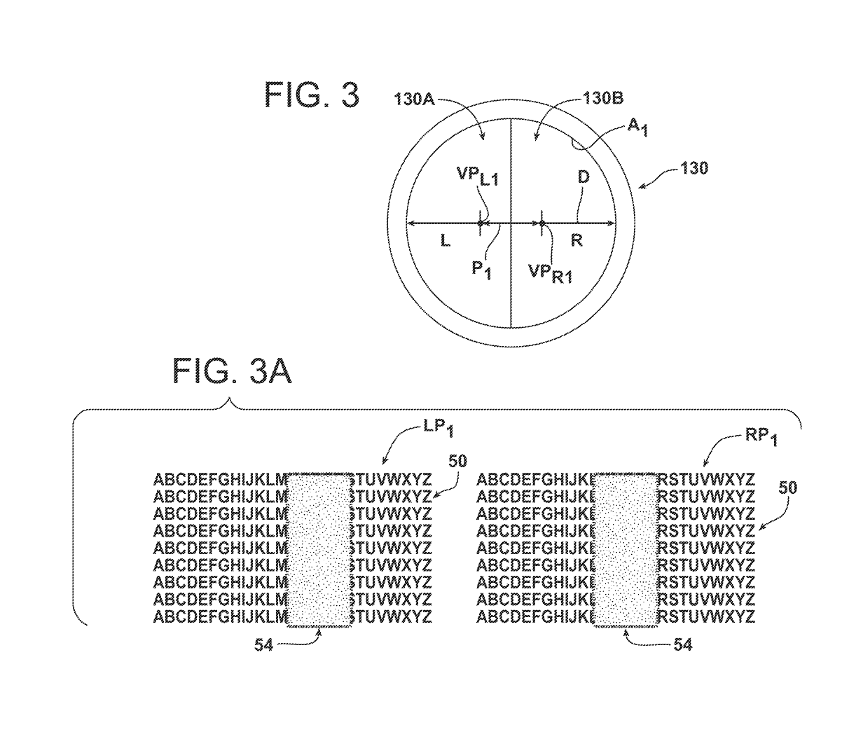

A second camera 100, see FIG. 4, includes a dividing device 130, see FIG. 3, used in combination with a lens system having a large diameter and operating at a low f-number. The dividing device 130, which may comprise a mechanical dividing device, comprises a generally circular area capable of defining left and right D-shaped pupils 130A and 130B. The dividing device 130 also functions as an aperture structure, which defines a circular aperture A₁ having a diameter D. The aperture A₁ is defined sequentially by the left and right D-shaped pupils 130A and 130B. In this example, the aperture A₁ has a defined circular area generally equal to the diameter of the lens system. Left and right viewpoints VP_{L1} and VP_{R1} of the corresponding left and right D-shaped pupils 130A and 130B at the dividing device 130, wherein the left and right pupils 130A and 130B are sequentially defined by the dividing device 130, are illustrated in FIG. 3. Also illustrated in FIG. 3 is a parallax P₁ of the lens system in the camera 100, which is equal to the distance between the left and right viewpoints VP_{L1} and VP_{R1}, wherein the left and right viewpoints VP_{L1} and VP_{R1} are located at the dividing device 130.

In FIG. 4, the camera 100 is shown taking a still image or video, i.e., a plurality of images, of a scene O₂ comprising text 50 on a wall 52 and a door 54 positioned between the wall 52 and the camera 100. When the left D-shaped pupil 130A of the dividing device 130 is light transmissive and the right D-shaped pupil 130B is opaque, a first left perspective image LP₁ of the scene O₂ is received at an image sensor of the camera 100, see FIG. 3A, which illustrates the first left perspective image LP₁ at the image sensor of the camera 100. When the left D-shaped pupil 130A of the dividing device 130 is opaque and the right D-shaped pupil 130B is light transmissive, a first right perspective image RP₁ of the scene O₂ is received at the image sensor of the camera 100. In the Example illustrated in FIGS. 3 and 3A, because the overall size of the aperture A₁ within the camera 100 is generally equal to the overall size of the lens system, the parallax of the lens system in the camera 100 is maximized. However, the depth of field is low due to the overall large size of the aperture A₁, which allows a substantial amount of light to pass through the lens system, resulting in the door 54 being out of focus in the first left and right perspective images LP₁ and RP₁ in FIG. 3A.

As noted above, in the embodiment illustrated in FIGS. 1 and 2, the electronically actuatable matrix shutter 30A functions as the aperture structure defining the aperture 40A. In accordance with the present invention, the size of the aperture 40A is defined such that it has a first length L₁ in a horizontal dimension HD and a second length L₂ in a vertical dimension VD. Preferably, the first length L₁ is substantially equal to a diameter of the lens system 20. As is apparent from FIG. 2, the first length L₁ is greater than the second length L₂ such that an effective f-number of the lens system 20 in the vertical dimension VD is greater than an effective f-number of the lens system 20 in the horizontal dimension HD. In other words, the overall f-number of the lens system 20 is increased when compared to a lens system used in combination with an aperture structure defining a generally circular aperture, such as the aperture A₁ illustrated in FIG. 3, and having a diameter D substantially equal to the first length L₁. While the aperture 40A has a generally rectangular shape in the embodiment illustrated in FIG. 2, it is contemplated that the aperture 40A may have an oval, elliptical or like shape. It is also contemplated that a ratio of the first length L₁ to the second length L₂ (L₁/L₂) may fall within a range of from about 1.0/0.8 to about 1.0/0.2 and, preferably, the ratio L₁/L₂ is equal to 1.0/0.5.

Returning again to FIG. 4, the camera 10 is illustrated taking a still image or video, i.e., a plurality of images, of the scene O₂ comprising text 50 on the wall 52 and the door 54 positioned between the wall 52 and the camera 10. When the first set 32A of shutter elements 32 are light transmissive and the second set 32B of shutter elements 32 are opaque, a second left perspective image LP₂ of the scene O₂ is received at the image sensor 14 of the camera 10, see FIG. 2A which illustrates the second left perspective image LP₂ at the image sensor of the camera 10. When the first set 32A of shutter elements 32 are opaque and the second set 32B of shutter elements 32 are light transmissive, a second right perspective image RP₂ of the scene O₂ is received at an image sensor of the camera 10.

Left and right viewpoints VP_{L2} and VP_{R2} of the corresponding left and right pupils 41 and 42 at the dividing device 30, wherein the pupils 41 and 42 are sequentially defined by the dividing device 30, are illustrated in FIG. 2. Also illustrated in FIG. 2 is a parallax P₂ of the lens system 20 in the camera 10, which is equal to the distance between the left and right viewpoints VP_{L2} and VP_{R2}, wherein the left and right viewpoints VP_{L2} and VP_{L2} are located at the dividing device 30.

In the Example illustrated in FIGS. 2 and 2A, the first length L₁ of the aperture 40A in the horizontal dimension HD is equal to 2 times the second length L₂ of the aperture 40A, thereby increasing the parallax P₂ of the lens system 20 in the camera 10. As the ratio of L₁/L₂ decreases from 2.0/1.0, the parallax P₂ of the lens system 20 decreases. As the ratio of L₁/L₂ increases from 2.0/1.0, the parallax P₂ of the lens system 20 increases but less light passes through the lens system 20 resulting in reduced image intensity on the image sensor.

Even though the generally circular aperture A₁ of the camera 100 has a diameter D substantially equal to the first length L₁ of the aperture 40A of the camera 10, the parallax P₂ of the lens system 20 in the camera 10 is greater than the parallax P₁ of the lens system in the camera 100 because centroids of the square-shaped left and right pupils 41 and 42, defining the left and right viewpoints VP_{L2} and VP_{R2}, are spaced further apart than centroids of the D-shaped pupils 130A and 130B, wherein the centroids define the left and right viewpoints VP_{L1} and VP_{R1}. Hence, the resolvable three-dimensional depth of the camera 10 increases relative to the resolvable three-dimensional depth of the camera 100, such that the door 54 in FIG. 2A appears further away from the text 50 on the wall 52 as compared to the door 54 in FIG. 3A. Further, the depth of field of the camera 10 is increased relative to the depth of field of the camera 100 due to the smaller overall size or area of the aperture 40A as compared to the size or area of the aperture A₁, resulting in the door 54 being more focused in FIG. 2A than in FIG. 3A.

An equation for finding the location of the centroid Cᵥ defining the left viewpoint VP_{L1} and the right viewpoint VP_{R1} is as follows:

$${C}_{V} ( R , h ) := \frac{\begin{matrix}\frac{8 \cdot {h}^{3}}{3 \cdot {R}^{2} \cdot ( \begin{matrix}2 asin ( \frac{h}{R} ) - \\ sin ( 2 asin ( \frac{h}{R} ) )\end{matrix} )} \cdot [ \frac{{R}^{2}}{2} \cdot ( \begin{matrix}2 asin ( \frac{h}{R} ) - \\ sin ( 2 asin ( \frac{h}{R} ) )\end{matrix} ) ] + \\ \sqrt{{R}^{2} - {h}^{2}} \cdot ( \sqrt{{R}^{2} - {h}^{2}} \cdot h \cdot 2 )\end{matrix}}{{R}^{2} \cdot ( \begin{matrix}2 asin ( \frac{h}{R} ) - \\ sin ( 2 asin ( \frac{h}{R} ) )\end{matrix} ) + \sqrt{{R}^{2} - {h}^{2}} \cdot h \cdot 2}$$

wherein:

r=radius of the lens system 20;

h=height of the aperture in the vertical dimension as measured from the center of the lens system 20;

Cv is measured from the center of the lens system along the horizontal dimension. Hence, the left viewpoint VPL2 is located to the left of the center of the lens system 20 at a distance equal to Cv and the right viewpoint VPR2 is located to the right of the center of the lens system 20 at a distance equal to Cv.

The parallax P2 of the lens system 20 is equal to 2×Cv.

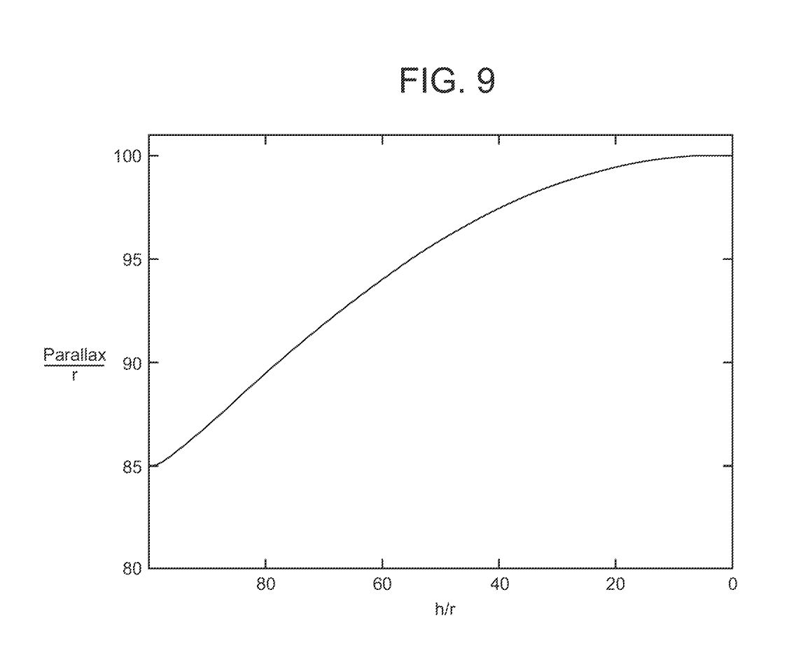

In FIG. 9, a plot is provided illustrating parallax/radius ratio percentages v. height/radius ratio percentages for a lens system 20 having a circular lens and an aperture with a first length L1 equal to the lens diameter and a height (h) in the vertical dimension as measured from the center of the lens. As is apparent from FIG. 9, parallax increases as height (h)/radius (r) decreases.

For a still image, only a single second left perspective image LP₂ and a single second right perspective image RP₂ are recorded sequentially by the image sensor 14. When the image sensor 14 comprises an electronic image sensor, the processor P is coupled to the image sensor 14 and processes the corresponding electronic image signals from the image sensor 14 and stores corresponding image data in the memory M. The image data in memory M may be provided to a further processor (not shown), which functions to assist in the display of a 3-D still image of the scene O₂ on a display monitor. When the image sensor comprises film, the two frames can be scanned and digitally processed so as to be displayed as a 3-D still image by a display monitor or viewed using an analog stereoscopic viewer.

For video imaging, alternating left perspective images LP₂ and right perspective images RP₂ are recorded by the image sensor 14. When the image sensor 14 comprises an electronic image sensor, the processor P is coupled to the image sensor 14 and processes the corresponding electronic image signals from the image sensor 14 and stores corresponding image data in the memory M. The image data in memory M may be provided to a further processor (not shown), which functions to display a 3-D video, i.e., a plurality of images, of the scene O₂ on a display monitor. When the image sensor comprises film, conventional shutter glasses may be used to view the displayed alternating left perspective images LP₂ and right perspective images RP₂.

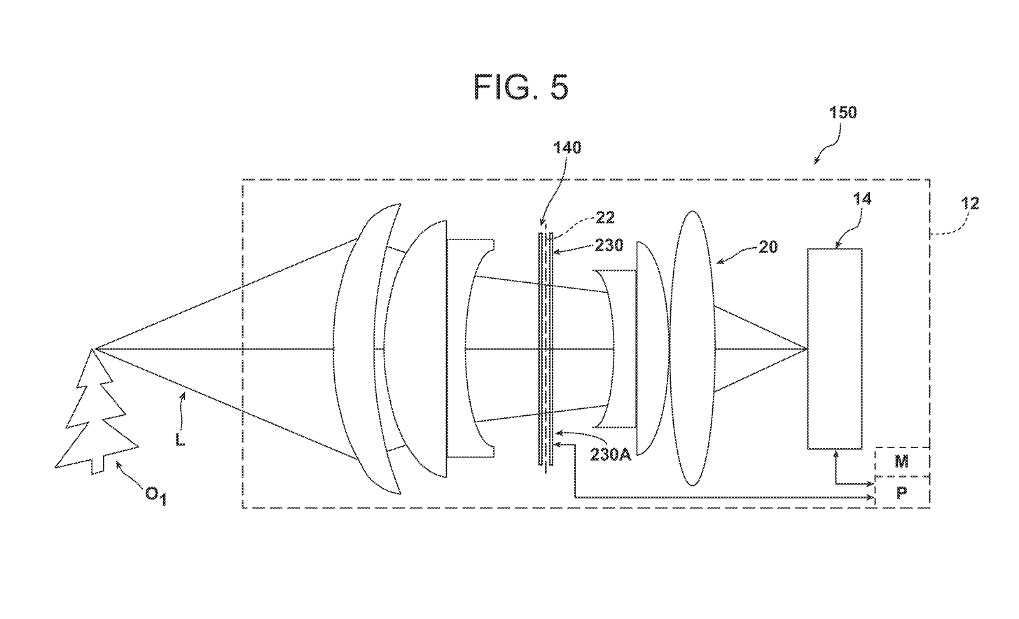

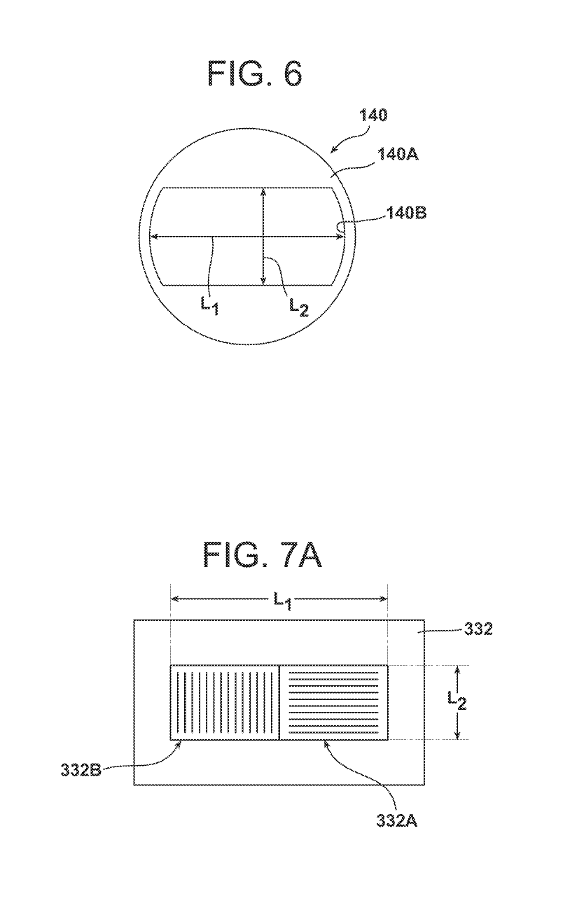

A stereoscopic camera 150 constructed in accordance with a second embodiment of the present invention is illustrated in FIG. 5, where elements similar to elements illustrated in FIG. 1 are referenced by like reference numerals. The camera 150 comprises a dividing device 230 comprising a mechanical shutter device 230A, which functions to separate the lens system 20 into first and second portions. The camera 150 also comprises a separate aperture structure 140 comprising a plate 140A having an aperture or opening 140B, see FIG. 6. The mechanical shutter device 230A may comprise a conventional single or multi-blade electronically actuated shutter, which is electronically actuated by the processor P.

The mechanical shutter device 230A functions to sequentially block light passing through left and right halves of the lens system 20 so as to provide left-eye and right-eye views of the object or scene O₁, which are imaged by the image sensor 14. The mechanical shutter device 230A and the image sensor 14 are synchronized and controlled by the processor P such that when the shutter device 230A blocks light through the left half of the lens system 20 and allows light to pass through the right half of the lens system 20, a right image of the object or scene O₁ is focused by the lens system 20 onto an image plane of the image sensor 14. In a similar manner, when the shutter device 230A and the image sensor 14 are synchronized and controlled by the processor P such that when the shutter device 230A blocks light through the right half of the lens system 20 and allows light to pass through the left half of the lens system 20, a left image of the object or scene O₁ is focused by the lens system 20 onto an image plane of the image sensor 14.

The size of the aperture 140B is defined such that it has a first length L₁ in a horizontal dimension HD and a second length L₂ in a vertical dimension VD. As is apparent from FIG. 6, the first length L₁ is greater than the second length L₂ such that an effective f-number of the lens system 20 in the vertical dimension VD is greater than an effective f-number of the lens system 20 in the horizontal dimension HD.

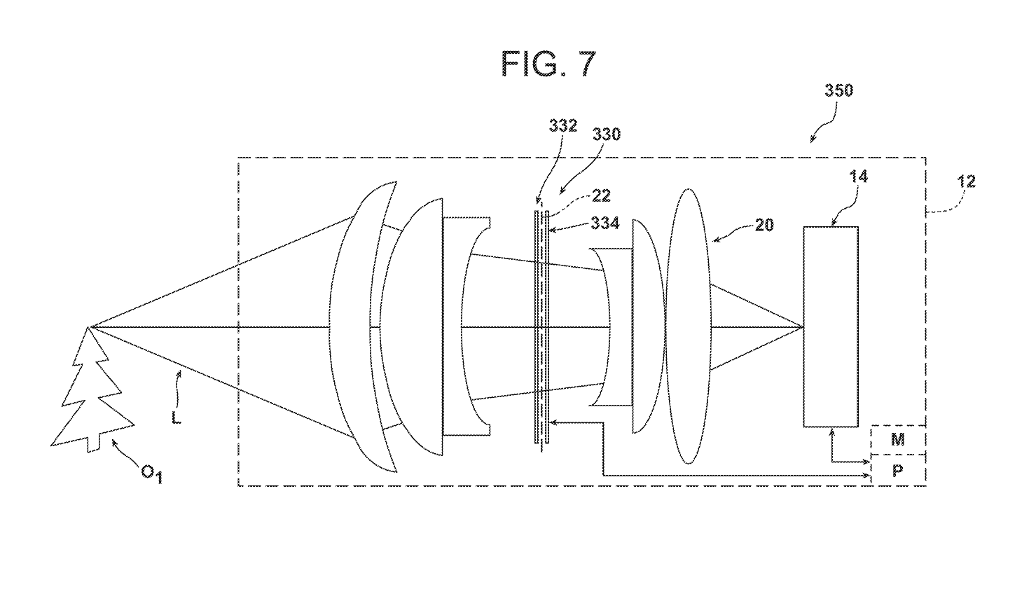

A stereoscopic camera 350 constructed in accordance with a third embodiment of the present invention is illustrated in FIG. 7, where elements similar to elements illustrated in FIG. 1 are referenced by like reference numerals. The camera 350 comprises a dividing device 330 comprising a passive polarizer structure 332 defining right and left portions 332A and 332B of different polarization states, and an active polarization selector 334, which is controlled by the processor P so as to sequentially allow light from the right and left portions 332A and 332B of the polarizer structure 332 to pass through the lens system 20. The passive polarizer structure 332 further defines the aperture structure so as to define an aperture having a first length L₁ in a horizontal dimension HD and a second length L₂ in a vertical dimension VD, see FIG. 7A.

The active polarization selector 334 functions to sequentially block light passing through left and right halves of the lens system 20 so as to provide left-eye and right-eye views of the object or scene O₁, which are imaged by the image sensor 14. The active polarization selector 334 and the image sensor 14 are synchronized and controlled by the processor P such that when the selector 334 blocks light through the left half of the lens system 20 and allows light to pass through the right half of the lens system 20, a right image of the object or scene O₁ is focused by the lens system 20 onto an image plane of the image sensor 14. In a similar manner, when the selector 334 and the image sensor 14 are synchronized and controlled by the processor P such that when the selector 334 blocks light through the right half of the lens system 20 and allows light to pass through the left half of the lens system 20, a left image of the object or scene O₁ is focused by the lens system 20 onto an image plane of the image sensor 14.

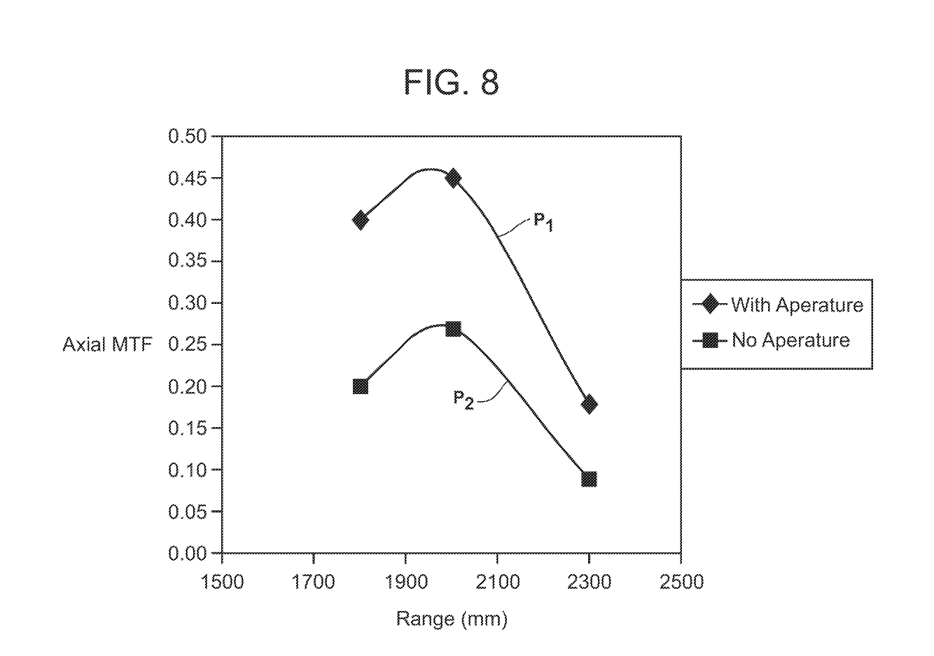

FIG. 8 illustrates a summary of a raytrace analysis generated for a double-gauss camera lens having an effective focal length of 50 mm, operating at a f-number of f/1.2 and having 24 degrees of field of view calculated at a fixed spatial frequency of 30 cycles per mm. Plot P₁ was generated when a plate with an aperture was positioned in front of the lens, wherein the plate had a first length of 3.5 inches in a horizontal dimension and a second length of 0.59 inch in a vertical dimension. The diameter of the lens was 60 mm. Plot P₂ was generated when no aperture was provided, but the same lens was used to generate plot P₂ as was used to generate plot P₁. In FIG. 8, Plots P₁ and P₂ comprise modulation transfer functions (MTF) (which are typical metrics of quality for optical systems, with high MTF values indicating better contrast and resolution with spatial frequency), which were used to illustrate the effect of the aperture positioned in front of the lens, wherein the lens was focused on a target at two meters distance. FIG. 8 illustrates that MTF was increased over a range of distance from the camera lens when the plate including the aperture was employed. Predominantly, this improvement occurred in a central portion of the field of view, as delineated by the axial MTF, which is the most important region of the image. So the net result was that more of the scene was in focus over a longer range from the camera, providing more three-dimensional information of a greater segment of the scene.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A stereoscopic camera comprising:
an image sensor;
a lens system adapted to focus light from a scene onto said image sensor;
a dividing device associated with said lens system for dividing the lens system into two portions; and
a structure associated with said lens system defining an aperture limiting an amount of light passing through at least a part of said lens system, said aperture having a first length in a first dimension which is greater than a second length in a second dimension so as to increase the parallax of the lens system.

2. The stereoscopic camera of claim 1, wherein said dividing device comprises a mechanical shutter.

3. The stereoscopic camera of claim 1, wherein said dividing device comprises an electronically actuatable matrix shutter capable of being actuated by a processor so as to sequentially create right and left pupils.

4. The stereoscopic camera of claim 1, wherein said dividing device is located upstream of said lens system.

5. The stereoscopic camera of claim 4, wherein said aperture structure is located adjacent to said dividing device.

6. The stereoscopic camera of claim 1, wherein said aperture structure is located an aperture stop of said lens system.

7. The stereoscopic camera of claim 1, wherein said aperture structure comprises a plate including an opening defining said aperture having a first length in a horizontal dimension which is greater than a second length in a vertical dimension.

8. The stereoscopic camera of claim 1, wherein said structure defining said aperture is adjustable.

9. The stereoscopic camera of claim 1, wherein said dividing device comprises:
a passive polarizer structure defining right and left portions of different polarization states; and
an active polarization selector which is controlled so as to sequentially allow light from said left and right portions of said polarizer structure to pass through said lens system.

10. The stereoscopic camera of claim 9, wherein said passive polarizer structure further defines said aperture structure.

11. The stereoscopic camera of claim 1, wherein said lens system comprises a double-gauss lens.

12. The stereoscopic camera of claim 1, wherein said aperture first length is substantially equal to a diameter of said lens system.

13. The stereoscopic camera of claim 1, wherein said dividing device sequentially divides the lens system into two portions.

14. The stereoscopic camera of claim 1, wherein a ratio of the first length to the second length falls within a range of from about 1.0/0.8 to 1.0/0.2.

15. A stereoscopic camera comprising:
an image sensor;
a lens system adapted to focus light from a scene onto said image sensor;
a dividing device associated with said lens system for dividing the lens system into two portions; and
a structure associated with said lens system defining an aperture limiting an amount of light passing through at least a part of said lens system, said aperture having a first length in a horizontal dimension which is greater than a second length in a vertical dimension such that an overall f-number of the lens system is increased when compared to an lens system having a generally circular aperture with a diameter substantially equal to said first length.

16. The stereoscopic camera of claim 15, wherein said dividing device comprises a mechanical shutter.

17. The stereoscopic camera of claim 15, wherein said dividing device is located upstream of said lens system.

18. The stereoscopic camera of claim 15, wherein said aperture structure is located an aperture stop of said lens system.

19. The stereoscopic camera of claim 15, wherein said dividing device comprises:
a passive polarizer structure defining right and left portions of different polarization states; and
an active polarization selector which is controlled so as to sequentially allow light from said left and right portions of said polarizer structure to pass through said lens system.

20. The stereoscopic camera of claim 15, wherein said aperture first length is substantially equal to a diameter of said lens system.
